(19) United States
(12) Patent Application Publication
(10) Pub. No.: US 2006/0142422 A1
(43) Pub. Date: Jun. 29, 2006

(54) Hydrolysis resistant polyester compositions and articles made therefrom

(76) Inventors: Toshikazu Kobayashi, Chadds Ford, PA (US); Hiroyuki Sumi, Tochigi-ken (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/291,166

(22) Filed: Dec. 1, 2005

Related U.S. Application Data
(60) Provisional application No. 60/633,893, filed on Dec. 7, 2004.

(51) Int. Cl. C08K 9/00; C08K 3/40

(52) U.S. Cl. 523/209; 524/494; 524/604

(57) ABSTRACT

Thermoplastic polyester compositions having low surface energies and comprising thermoplastic polyester, at least one mineral coated with a polysiloxane, and at least one impact modifier. Articles formed from the composition are disclosed.

### CROSS REFERENCE TO RELATED APPLICATIONS

This application claims the benefit of U.S. Provisional Application No. 60/633,893, filed Dec. 7, 2004.

### FIELD OF THE INVENTION

The present invention relates to hydrolysis and solvent resistant thermoplastic polyester compositions. The compositions comprise at least one thermoplastic polyester, at least one mineral coated with a polysiloxane, and at least one impact modifier.

### BACKGROUND OF THE INVENTION

Because of their excellent mechanical and electrical properties, thermoplastic polyester resin compositions are used in a broad range of applications, such as in automotive parts, electrical and electronic parts, machine parts, and the like. However, in many of these applications, including under the hood automotive applications, the parts are exposed to chemicals including water, alcohols, and alkaline solutions, often at elevated temperatures. Under such conditions, thermoplastic polyesters can be susceptible to hydrolysis, which can lead to degradation of their physical properties. Materials having low surface energies are difficult to wet with liquids, including water, alcohols, and alkaline solutions, and other chemicals, which can make it more difficult for the liquids to penetrate into the materials, and hence hydrolyze or otherwise degrade them from within. Thus it would be desirable to obtain a polyester resin composition having a low surface energy and improved hydrolysis and solvent resistance.

Japanese published patent application 2002-356611 discloses a poly(butylene terephthalate) composition containing polycarbonate, an elastomer, a fibrous reinforcing agent, and a silicone compound having a melt-viscosity at 25° C. of less than 10000 mm²/s.

### SUMMARY OF THE INVENTION

There is disclosed and claimed herein a hydrolysis resistant polyester resin composition comprising:
(a) about 40 to about 96.9 weight percent of at least one thermoplastic polyester;
(b) about 0.1 to about 10 weight percent of at least one mineral that has been coated with at least one polysiloxane;
(c) about 3 to about 30 weight percent of at least one impact modifier;
(d) 0 to about 50 weight percent of at least one reinforcing agent;
   where the above-stated weight percentages of components (a)-(d) are based on the total weight of the composition

Articles made from the composition of the invention are also disclosed herein.

### DETAILED DESCRIPTION OF THE INVENTION

The polyester resin composition of the present invention comprises a thermoplastic polyester, a polysiloxane coated mineral, and an impact modifier.

In general, any thermoplastic polyester may be used in the present invention. The thermoplastic polyester may comprise mixtures of two or more thermoplastic polyesters. The term “thermoplastic polyester” as used herein includes polymers that have an inherent viscosity of 0.3 or greater and are, in general, linear saturated condensation products of diols and dicarboxylic acids. The terms “carboxylic acid” and “dicarboxylic acid” as used herein refer also to the corresponding carboxylic acid derivatives of these materials, which can include carboxylic acid esters, diesters, and acid chlorides.

Preferably, the thermoplastic polyester is a condensation product of a dicarboxylic acid component comprising at least one aromatic dicarboxylic acid having 8 to 14 carbon atoms and a diol component comprising at least one diol selected from neopentyl glycol, cyclohexanedimethanol, 2,2-dimethyl-1,3-propane diol, and aliphatic glycols of the formula HO(CH₂)ₙOH, where n is an integer from 2 to 10. The diol component may further comprise up to about 20 mole percent of one or more aromatic diols including, for example, ethoxylated bisphenol A, which is sold under the tradename Dianol 220 by Akzo Nobel Chemicals, Inc.; hydroquinone; biphenol; and bisphenol A. The dicarboxylic acid component may further comprise up to about 20 mole percent of one or more aliphatic dicarboxylic acids having from 2 to 12 carbon atoms. Difunctional hydroxy acid monomers, such as, for example, hydroxybenzoic acid; hydroxynaphthoic acid, and reactive equivalents thereof may also be used as comonomers.

Preferred thermoplastic polyesters include poly(ethylene terephthalate) (PET), poly(1,4-butylene terephthalate) (PBT), poly(propylene terephthalate) (PPT), poly(1,4-butylene naphthalate) (PBN), poly(ethylene naphthalate) (PEN), poly(1,4-cyclohexylene dimethylene terephthalate) (PCT), or copolymers or mixtures thereof. Also preferred are 1,4-cyclohexylene dimethylene terephthalate/isophthalate copolymers. The thermoplastic polyester is also preferably selected from random copolymers of at least two of PET, PBT, and PPT; mixtures of at least two of PET, PBT, and PPT; and mixtures of at least one PET, PBT, and PPT with at least one random copolymer of at least two of PET, PBT, and PPT.

Examples of aromatic dicarboxylic acids having from 8-14 carbon atoms, include, but are not limited to, isophthalic acid; bibenzoic acid; naphthalenedicarboxylic acids, including, for example, 1,5-naphthalenedicarboxylic acid, 2,6-naphthalenedicarboxylic acid, and 2,7-naphthalenedicarboxylic acid; 4,4′-diphenylenedicarboxylic acid; bis(p-carboxyphenyl) methane; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid.

Examples of aliphatic dicarboxylic acids having from 2 to 12 carbon atoms include, but are not limited to, adipic acid, sebacic acid, azelaic acid, dodecanedioic acid, and 1,4-cyclohexanedicarboxylic acid.

Examples of aliphatic glycols of the general formula HO(CH₂)ₙOH where n is an integer from 2 to 10, include, but are not limited to, ethylene glycol; 1,3-trimethylene glycol; 1,4-tetramethylene glycol; 1,6-hexamethylene glycol; 1,8-octamethylene glycol; 1,10-decamethylene glycol; 1,3-propylene glycol; or 1,4-butylene glycol.

The thermoplastic polyester may also be in the form of copolymers that contain poly(alkylene oxide) soft segments. Such copolymers may contain from about 1 to about 15 parts by weight poly(alkylene oxide) soft segments per 100 parts per weight of thermoplastic polyester. The poly(alkylene oxide) soft segments preferably have a number average molecular weight in the range of about 200 to about 3,250, and more preferably in the range of about 600 to about 1,500. Methods of incorporation are known to those skilled in the art, such as, for example, using the poly(alkylene oxide) soft segment as a comonomer during the polymerization reaction that forms the polyester. PET may be blended with copolymers of PBT and at least one poly(alkylene oxide). A poly(alkyene oxide) may also be blended with a PET/PBT copolymer.

The thermoplastic polyester is present in the composition in about 40 to about 99.5 weight percent, or more preferably about 50 to about 85 weight percent, based on the total weight of the composition.

The polysiloxane coated mineral comprises a mineral having a number average

particle diameter of no more than about 10 micrometers, or more preferably no more than about 3 micrometers. Examples of suitable minerals include silica (silicone dioxide), talc, bentonite clays, wollastonite, alumina, mica, zinc oxide, and kaolin clays. The mineral may be synthetic or naturally-occurring. The minerals are preferably selected from minerals that have oxygen- or hydroxy-containing groups on their surfaces. The minerals are surface coated with at least one polysiloxane having a number average molecular weight of at least 10,000, or preferably at least 20,000. Examples of polysiloxanes include: polydimethylsiloxane, polymethylethylsiloxane, polydiethylsiloxane, polydihexylsiloxane, polydiphenylsiloxane, polyphenylmethylsiloxane, polydipropylsiloxane, polydicyclohexylsiloxane, polydicyclopentylsiloxane, polymethylcyclopentylsiloxane, polydicyclobutylsiloxane, polymethylcyclohexylsiloxane, and polydicycloheptylsiloxane. The polysiloxanes are preferably solids at 25° C. A silane coupling agent may be used to bind the polysiloxane to the mineral.

The polysiloxane coated mineral preferably comprises about 10 to about 80 weight percent, or more preferably about 40 to about 70 weight percent polysiloxane and preferably about 20 to about 90 weight percent, or more preferably about 30 to about 60 weight percent mineral, wherein the weight percentages are based on the total weight of the polysiloxane coated mineral.

The polysiloxane coated mineral is present in about 0.1 to about 10 weight percent, or preferably in about 0.5 to about 5 weight percent, based on the total weight of the composition.

The composition of the present invention further comprises one or more impact modifiers. Suitable impact modifiers preferably have relatively low melting points, generally <200° C., and preferably <150° C. and preferably comprise functional groups that can react with the polyester. Since thermoplastic polyesters usually have carboxyl and hydroxyl groups present, these functional groups usually can react with carboxyl and/or hydroxyl groups. Examples of such functional groups include epoxy, carboxylic anhydride, hydroxyl (alcohol), carboxyl, and isocyanate. Preferred functional groups are epoxy, and carboxylic anhydride, and epoxy is especially preferred. Such functional groups are usually “attached” to the polymeric impact modifier by grafting small molecules onto an already existing polymer or by copolymerizing a monomer containing the desired functional group when the polymeric impact modifier molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric impact modifier wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl (meth)acrylate, glycidyl (meth)acrylate, and 2-isocyanatoethyl (meth)acrylate. In addition to ethylene and a functional (meth)acrylate monomer, other monomers may be copolymerized into such a polymer, such as vinyl acetate, unfunctionalized (meth)acrylate esters such as ethyl (meth)acrylate, n-butyl (meth)acrylate, and cyclohexyl (meth)acrylate. Carbon monoxide may be used as a comonomer. Preferred toughening agents include those listed in U.S. Pat. No. 4,753,980, which is hereby included by reference. Especially preferred impact modifiers are copolymers of ethylene, ethyl acrylate or n-butyl acrylate, and glycidyl methacrylate, such as ethylene/n-butyl acrylate/glycidyl methacrylate copolymers (EBAGMA). Also preferred are ethylene/n-butyl acrylate/carbon monoxide copolymers (EnBACO).

It is preferred that the impact modifier be derived from about 0.5 to about 20 weight percent of monomers containing functional groups, preferably about 1.0 to about 15 weight percent, more preferably about 7 to about 13 weight percent of monomers containing functional groups. There may be more than one type of functional monomer present in the impact modifier. It has been found that toughness of the composition is increased by increasing the amount of impact modifier and/or the amount of functional groups. However, these amounts should preferably not be increased to the point that the composition may crosslink, especially before the final part shape is attained.

The impact modifier used with thermoplastic polyesters may also be thermoplastic acrylic polymers that are not copolymers of ethylene. The thermoplastic acrylic polymers are made by polymerizing acrylic acid, acrylate esters (such as methyl acrylate, n-propyl acrylate, isopropyl acrylate, n-butyl acrylate, n-hexyl acrylate, and n-octyl acrylate), methacrylic acid, and methacrylate esters (such as methyl methacrylate, n-propyl methacrylate, isopropyl methacrylate, n-butyl methacrylate (BA), isobutyl methacrylate, n-amyl methacrylate, n-octyl methacrylate, glycidyl methacrylate (GMA) and the like). Copolymers derived from two or more of the forgoing types of monomers may also be used, as well as copolymers made by polymerizing one or more of the forgoing types of monomers with styrene, acryonitrile, butadiene, isoprene, and the like. Part or all of the components in these copolymers should preferably have a glass transition temperature of not higher than 0° C. Preferred monomers for the preparation of a thermoplastic acrylic polymer impact modifier are methyl acrylate, n-propyl acrylate, isopropyl acrylate, n-butyl acrylate, n-hexyl acrylate, and n-octyl acrylate.

It is preferred that a thermoplastic acrylic polymer impact modifier have a core-shell structure. The core-shell structure is one in which the core portion preferably has a glass transition temperature of 0° C. or less, while the shell portion is preferably has a glass transition temperature higher than that of the core portion. The core portion may be grafted with silicone. The shell section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition.

The one or more impact modifiers are present in about 3 to about 30 weight percent, based on the total weight of the composition.

The composition of the present invention may optionally further comprise up to about 50 weight percent, based on the total weight of the composition, of one or more reinforcing agents. Examples of suitable reinforcing agents include glass fibers, glass flakes, mica, wollastonite, mica, synthetic resin fibers, and the like. When glass reinforcing agents are used, they will preferably be coated with a silane or epoxy sizing and a polyurethane or epoxy binder. The epoxy binder may be a bisphenol A/epichlorohydrin condensation product, or preferably a novolac epoxy. When used, the reinforcing agents will preferably be present in about 10 to about 50 weight percent, based on the total weight of the composition.

The composition of the present invention may optionally comprise additives such as one or more plasticizers, one or more nucleating agents, heat stabilizers, antioxidants, dyes, pigments, UV stabilizers, lubricants, mold release agents, and the like. Examples of suitable plasticizers include poly(ethylene glycol) 400 bis(2-ethyl hexanoate); methoxypoly(ethylene glycol) 550 (2-ethyl hexanoate); and tetra(ethylene glycol) bis(2-ethyl hexanoate). Examples of suitable nucleating agents include a sodium or potassium salt of a carboxylated organic polymer; the sodium salt of a long chain fatty acid; and sodium benzoate.

The compositions of the present invention are melt-mixed blends, wherein all of the polymeric components are well-dispersed within each other and all of the non-polymeric ingredients are dispersed in and bound by the polymer matrix, such that the blend forms a unified whole. Any melt-mixing method may be used to combine the polymeric components and non-polymeric ingredients of the present invention.

For example, the polymeric components and non-polymeric ingredients may be added to a melt mixer, such as, for example, a single or twin-screw extruder; a blender; a kneader; or a Banbury mixer, either all at once through a single step addition, or in a step-wise fashion, and then melt-mixed. When adding the polymeric components and non-polymeric ingredients in a step-wise fashion, part of the polymeric components and/or non-polymeric ingredients are first added and melt-mixed with the remaining polymeric components and non-polymeric ingredients being subsequently added and further melt-mixed until a well-mixed composition is obtained.

The composition of the present invention may be formed into articles using methods known to those skilled in the art, such as, for example, injection molding; blow molding; or extrusion. Such articles can include those for use in electrical and electronic applications, mechanical machine parts, and automotive applications. Examples of articles include housings and sensor housings, particular for automotive applications, and exterior automotive parts such as wiper arms and in particular wiper arms used for rear windows.

### EXAMPLES

Sample Preparation and Physical Testing

All of the components shown in Table 1 with the exception of the glass fibers were combined and fed to the rear of a ZSK 40 mm twin screw extruder and melt mixed using at a melt temperature of about 280° C. to yield a resin composition. The glass fibers were side-fed to the extruder. Exiting the extruder, the composition was passed through a die to form strands that were cooled and solidified in a quench tank and subsequently chopped to form pellets.

The resultant compositions were molded into 4 mm ISO all-purpose bars. The test pieces were used to measure mechanical properties on samples at 23° C. and dry as molded. The following test procedures were used and the results are given in Table 1:
Tensile strength and elongation at break: ISO 527-½
Flexural modulus and strength: ISO 178
Notched and unnotched Izod impact strength: ISO 180

Test bars were also conditioned in an autoclave at 121° C., 2 atm, and 100% relative humidity for 50 and 100 hours. Mechanical properties were measured on the conditioned test bars and the results were compared to the properties of the unconditioned bars. The mechanical properties of the conditioned bars and the percentage retention of the physical properties are given in Table 1. A greater retention of physical properties indicates better hydrolysis resistance.

Test bars were also formed by injecting the composition into a 4 mm all-purpose bar mold having gates on either end of the mold. The molten material met at the center, forming a bar with a weld line (referred to as “welded bar” in Table 1). The tensile strength and percent elongation at break of the welded bars were measured using the methods mentioned above before and after conditioning and the results are given in Table 1. The welded bars are believed to contain small cracks at the weld line. These cracks can provide a point of entry of water during hydrolysis testing. Welded bars having a greater retention of tensile strength after conditioning are deemed to have better hydrolysis resistance.

Surface tension was calculated using the Owens-Wendt method from the contact angle measured for a 1.8 μL drop of water and a 0.4 μL drop of diiodomethane on molded tensile bars.

The following terms are used in Table 1:

Poly(butylene terephthalate) refers to Crastin® 6003, manufactured by E.I. du Pont de Nemours and Co., Wilmington, Del.

Antioxidant refers to Irganox® 1010, manufactured by Ciba Specialty Chemicals, Inc., Tarrytown, N.Y.

Carbon black refers to Cabot PE3324, containing 30 weight percent carbon black in a polyethylene carrier and manufactured by Cabot Corp., Boston, Mass.

Lubricant A refers to Loxiol VPG861, a pentaerythritol tetrastearate lubricant manufactured by Cognis Corp., Cincinnati, Ohio.

Lubricant B refers to Wax OP, a lubricant manufactured by Clariant Corp., Charlotte, N.C.

Silicone oil refers to SH 200 300CS silicone oil, manufactured by Toray Dow Corning, Tokyo Japan.

Coated silica refers to Torefil F-202, a coated silica having an average particle diameter of 1 micrometer, where the coating is a polydimethysiloxane having a number average molecular weight of 65,000 and wherein the polydimethylsiloxane is present in about 60 weight percent, based on the total weight of the coated silica.

Impact modifier refers to Elvaloy® EP 49344, an ethylene/butyl acrylate/glycidyl methacrylate polymer manufactured by E.I. du Pont de Nemours and Co., Wilmington, Del.

Epon® 1009 is an epoxy resin manufactured by Resolution Performance Products, Houston, Tex.

Glass fibers is Asahi 03 JA FT 592, manufactured by Asahi Glass, Tokyo, Japan.

TABLE 1

| | | Comp. | Comp. | Comp. |
|---|---|---|---|---|
| | Example 1 | Ex. 1 | Ex. 2 | Ex. 3 |
| PBT | 54.2 | 55.2 | 56.7 | 66.9 |
| Antioxidant | 0.2 | 0.2 | 0.2 | 0.3 |
| Carbon black | 2 | 2 | 2 | 2 |
| Lubricant A | 0.5 | 0.5 | 0.5 | — |
| Lubricant B | — | — | — | 0.2 |
| Silicone oil | — | 1.5 | — | — |
| Coated silica | 2.5 | — | — | — |
| Impact modifier | 10 | 10 | 10 | — |
| Epon ® 1009 | 0.6 | 0.6 | 0.6 | 0.6 |
| Glass fibers | 30 | 30 | 30 | 30 |
| Dry as molded | | | | |
| Tensile strength (MPa) | 115 | 116 | 117 | 137 |
| Elongation at break (%) | 3.5 | 3.5 | 3.5 | 3.3 |
| Flexural strength (MPa) | 181 | 182 | 183 | 209 |
| Flexural modulus (MPa) | 7485 | 7721 | 7852 | 8583 |
| Notched Izod impact | 15 | 16 | 19 | 13 |
| strength (kJ/m²) | | | | |
| Unnotched Izod impact | 81 | 77 | 80 | 69 |
| strength (kJ/m²) | | | | |
| Welded bar dry as molded | | | | |
| Tensile strength (MPa) | 34 | 34 | 37 | 61 |
| Elongation at break (%) | 1.1 | 1.2 | 1.2 | 1.2 |
| After conditioning for 50 h | | | | |
| Tensile strength (MPa) | 102 | 103 | 100 | 60 |
| % retention of tensile | 89 | 89 | 85 | 44 |
| strength (%) | | | | |
| After conditioning for 100 h | | | | |
| Tensile strength (MPa) | 65 | 61 | 61 | 27 |
| % retention of tensile | 57 | 53 | 52 | 20 |
| strength (%) | | | | |
| Welded bar after | | | | |
| conditioning for 50 h | | | | |
| Tensile strength (MPa) | 24 | 14 | 14 | 10 |
| % retention of tensile | 71 | 41 | 38 | 16 |
| strength (%) | | | | |
| Surface tension (dyne/cm) | 31 | 31 | 38 | 41 |

Ingredient quantities are in weight percent based on the total weight of the composition.

A comparison of Example 1 with Comparative Example 3 demonstrates that the addition of a mineral coated with a polysiloxane and an impact modifier to a polyester composition provides a composition having decreased surface tension and improved hydrolysis resistance. A comparison of Example 1 with Comparative Example 2 demonstrates that the presence of a mineral coated with a polysiloxane to a polyester composition containing an impact modifier provides a composition having decreased surface tension and greatly improved hydrolysis resistance. A comparison of Example 1 with Comparative Example 3 indicates that the addition of a mineral coated with a polysiloxane to a polyester composition comprising an impact modifier provides a composition having improved hydrolysis resistance over a composition comprising polyester, impact modifier, and silicone oil.

What is claimed is:

1. A thermoplastic polyester resin composition comprising:
(a) about 40 to about 96.9 weight percent of at least one thermoplastic polyester;
(b) about 0.1 to about 10 weight percent of at least one mineral that has been coated with at least one polysiloxane;
(c) about 3 to about 30 weight percent of at least one impact modifier;
(d) 0 to about 50 weight percent of at least one reinforcing agent;
where the above-stated weight percentages of components (a)-(d) are based on the total weight of the composition.

2. The composition of claim 1, wherein the mineral (b) is silica.

3. The composition of claim 1, wherein the polysiloxane has a number average molecular weight of at least 10,000.

4. The composition of claim 1, wherein the polysiloxane has a number average molecular weight of at least 20,000.

5. The composition of claim 1, wherein the polysiloxane is polydimethylsiloxane.

6. The composition of claim 1, wherein the mineral has a number average particle diameter of no more than about 10 micrometers.

7. The composition of claim 1, wherein the mineral has number average particle size of no more than about 3 micrometers.

8. The composition of claim 1, wherein the polyester is one or more of poly(ethylene terephthalate), poly(1,4-butylene terephthalate), poly(propylene terephthalate), poly(1,4-butylene naphthalate) (PBN), poly(ethylene naphthalate), poly(1,4-cyclohexylene dimethylene terephthalate), or copolymers thereof.

9. The composition of claim 1, wherein the reinforcing agent is present in about 10 to about 50 weight percent.

10. The composition of claim 9, wherein the reinforcing agent is glass fibers.

11. The composition of claim 1, wherein the impact modifier comprises an ethylene/n-butyl acrylate/glycidyl methacrylate copolymer.

12. The composition of claim 1, wherein the impact modifier comprises an ethylene/n-butyl acrylate/carbon monoxide copolymer.

13. The composition of claim 1 further comprising one or more plasticizers, nucleating agents, heat stabilizers, anitoxidants, dyes, pigments, UV stabilizers, lubricants, or mold release agents.

14. An article molded from the composition of claim 1.

15. The article of claim 14 in the form of a housing.

16. The article of claim 15 in the form of sensor housing.

17. The article of claim 16 in the form of an automobile sensor housing.

18. The article of claim 14 in the form of a automobile window wiper arm.
